(19) United States
(12) Patent Application Publication
(10) Pub. No.: US 2002/0111177 A1
(43) Pub. Date: Aug. 15, 2002

(54) Method and a data structure for managing animation of icons defined in a message, and a mobile terminal for executing said message

(75) Inventors: Christophe Castres, Cormeilles En Parisis (FR); Gilles Ambone, Courbevoie (FR)

Correspondence Address: SUGHRUE, MION, ZINN, MACPEAK & SEAS, PLLC, Suite 800, 2100 Pennsylvania Avenue, N.W., Washington, DC, 20037-3213, US

(73) Assignee: ALCATEL

(21) Appl. No.: 10/073,147

(22) Filed: Feb. 13, 2002

(30) Foreign Application Priority Data
Feb. 15, 2001 (FR) 01 02 072

(51) Int. Cl. H04Q 7/20

(52) U.S. Cl. 455/466; 455/566

(57) ABSTRACT

The message is transmitted over a telecommunication network between a sender terminal and a receiver terminal. In the method according to the invention, a data structure is constructed in which the icons are associated with a sequence of words for managing the animation of the icons, including a first type of word defining an icon display time and a second type of word defining a cross-reference to a selected icon defined in the data structure; the sequence is then executed so that the display time of a selected icon is imposed by the last word of the first type that precedes the word of the second type cross-referencing the selected icon.

The present invention relates to a method and a data structure for managing animation of icons defined in a message, and to a mobile terminal that can implement the method.

### BACKGROUND OF THE INVENTION

Most providers of access to wireless telecommunication networks, in particular the GSM (Global System for Mobile communications) cellular telecommunication network, offer a message service for mobile terminals to send and receive messages, generally text messages. One message service of this type is the Short Message Service (SMS). An enhancement to the features of the SMS, known as the Enhanced Messaging Service (EMS), has recently been proposed, with a view to standardizing transmission in a wireless telecommunication network of messages in which icons are defined, for example.

### OBJECTS AND SUMMARY OF THE INVENTION

An object of the invention is to manage animation of icons defined in a message transmitted over a telecommunication network, to be more specific a wireless network, between a sender and a receiver, using a method that is compatible, where applicable, with the features of an EMS.

To this end, the invention provides a method of managing animation of icons defined in a message transmitted over a telecommunication network between a sender terminal and a receiver terminal, wherein:

a data structure is constructed in which the icons are associated with a sequence of words for managing animation of the icons, including a first type of word defining an icon display time and a second type of word defining a cross-reference to a selected icon defined in the data structure, and

the sequence is executed so that the display time of a selected icon is imposed by the last word of the first type that precedes the word of the second type cross-referencing the selected icon.

According to features of various embodiments of the method:

the sequence is defined in a data medium of the receiver terminal and the data structure is constructed in the receiver terminal;

the message in which the icons are defined is an EMS (Enhanced Messaging Service) message;

the data structure is constructed in the message transmitted between the sender terminal and the receiver terminal;

the message transmitted between the sender terminal and the receiver terminal is an SMS (Short Message Service) message;

the icons to be animated are defined one after the other in the data structure;

the icon defined first in the data structure is directly preceded by the animation management sequence;

in the data structure, the animation management sequence is directly preceded by a word defining the size of the sequence;

the first word of the animation management sequence is of the first type;

the words and the icons are defined by bytes and the words of the second type define a byte skip;

the words of the first type defining an icon display time are coded by a series of bits including a first part defining a predetermined code identifying the type of word and a second part defining an icon display time parameter;

the words of the first and second types are numbers expressed in hexadecimal notation;

the words of the first and second types are coded on 16 bits;

in words of the first type, the predetermined code identifying the type of word is coded by the first four bits and the icon display time parameter is coded by the last twelve bits;

the telecommunication network is a wireless network, in particular a GSM (Global System for Mobile communications) network.

The invention also provides a mobile terminal including means for implementing the method defined above.

The invention further provides a data structure for managing animation of icons defined in a message transmitted over a telecommunication network between a sender terminal and a receiver terminal, the data structure including data defining the icons and a sequence of words for managing animation of the icons including a first type of word defining an icon display time and a second type of word defining a cross-reference to a selected icon defined in the data structure, the display time of a selected icon being imposed by the last word of the first type that precedes the word of the second type cross-referencing the selected icon.

According to other features of the structure:

the icons to be animated are defined one after the other in the data structure;

the icon defined first in the data structure is directly preceded by the animation management sequence;

the structure includes a word defining the size of the animation management sequence and directly preceding that sequence;

the first word of the animation management sequence is of the first type;

the words and the icons are defined by bytes and the words of the second type define a byte skip;

the words of the first type defining an icon display time are coded by a series of bits including a first part defining a predetermined code identifying the type of word and a second part defining an icon display time parameter;

the words of the first and second types are numbers expressed in hexadecimal notation;

the words of the first and second types are coded on 16 bits;

in words of the first type, the predetermined code identifying the type of word is defined by the first four bits and the icon display time parameter is defined by the last twelve bits.

### BRIEF DESCRIPTION OF THE DRAWING

The invention will be better understood after reading the following description, which is given by way of example only and with reference to the drawing, in which:

FIG. 1 is a diagrammatic view of a mobile terminal according to the invention, and

FIG. 2 is a timing diagram illustrating the method according to the invention.

### MORE DETAILED DESCRIPTION

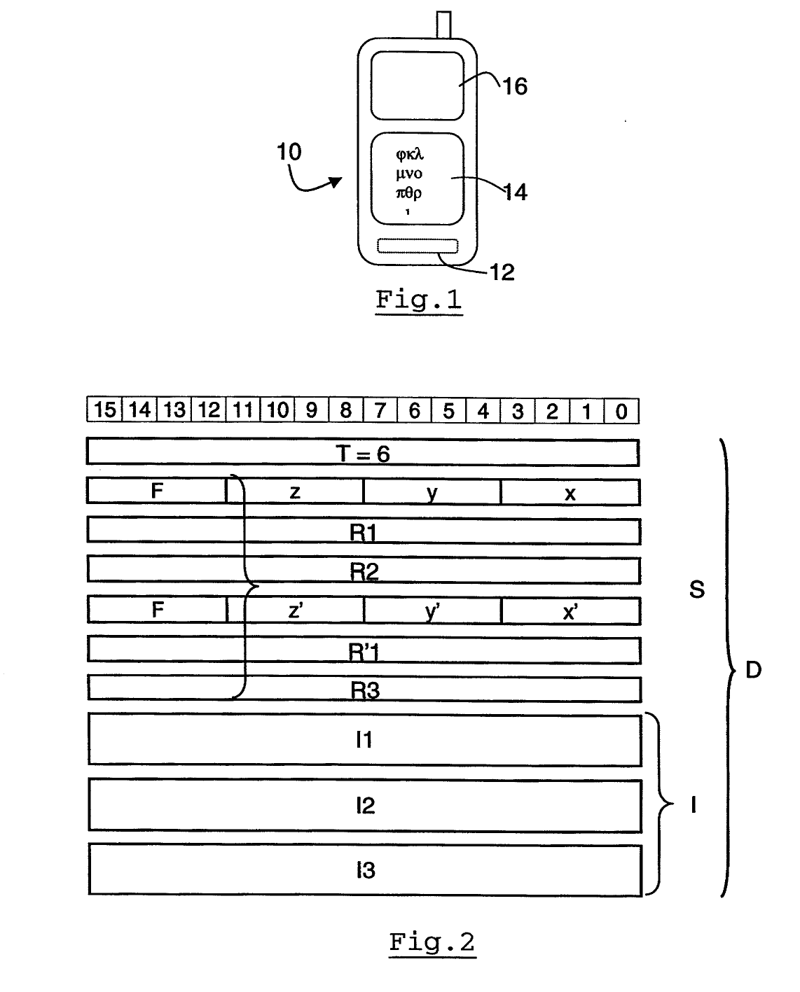

FIG. 1 shows a mobile terminal 10 including means 12 for implementing a method of managing animation of icons, as described below. The terminal 10 is either a sender or a receiver.

The terminal 12 includes data entry means 14 and data display means 16, for example a liquid crystal display screen.

The icons are defined in a message transmitted over a telecommunication network between a sender terminal and a receiver terminal, each terminal consisting of a terminal 10 such as that shown in FIG. 1, for example.

The telecommunication network is a wireless network, for example a network conforming to the GSM (Global System for Mobile communications) standard.

The icons that are animated are defined in a grouped manner in the message, one after the other, for example as in an EMS (Enhanced Messaging Service) message.

In the example shown in FIG. 2, there is a group I of three successive icons I1 to I3. The icons I1 to I3 are defined in a format suitable for display on the screen of a terminal such as that shown in FIG. 1, for example a liquid crystal display screen.

The method according to the invention constructs a data structure D in which data defining the icon is associated with a sequence S of words for managing animation of the icons.

The icons I1 to I3 that are animated are defined one after the other in the data structure D. The icon defined first in the data structure D, i.e. the icon I1 in the FIG. 2 example, is directly preceded by the animation management sequence S.

The sequence S is directly preceded by a word defining the size of the sequence S. Thus in the example shown in FIG. 2 the size T of the sequence S is six words.

The word indicating the size T of the sequence S and the words of that sequence S are coded on 16 bits, for example, and expressed in hexadecimal notation.

The sequence S includes a first type of word defining an icon display time. Words of the first type are coded by a series of bits including a first part defining a predetermined code identifying the type of word and a second part defining an icon display time parameter.

In the example shown in FIG. 2, the predetermined code identifying the type of word is defined by the first four bits and the icon display time parameter is defined by the last twelve bits. To be more specific, using hexadecimal notation, the predetermined identification code is F. Accordingly, in the example, a word of the first type is written as follows in hexadecimal notation: Fzyx.

By fixing at 100 ms the unit of the icon display time parameter defined on 12 bits, the display time can be varied between 0 and 2¹²×100 ms (6′49″ 500 ms).

Note that the first word of the animation management sequence S is of the first type.

The sequence S also includes a second type of word defining a cross-reference to a selected icon defined in the data structure D. In the example described, the words and the icons are defined by bytes and the words of the second type define a byte skip, which may be relative to a reference word. Furthermore, a word of the second type has a hexadecimal value less than F000 in order to distinguish it from a word of the first type.

In the example shown in FIG. 2, the first word of the sequence S is of the first type and defines a display time Fzyx.

The second word of the sequence S is of the second type and defines a cross-reference R1 to the first icon I1 defined after the sequence S. The cross-reference R1 causes the selected icon I1 to be displayed on the display means 16 of the terminal 10 for the display time Fzyx.

The third word of the sequence S is also of the second type and defines a cross-reference R2 to the second icon I2 defined after the sequence S. The cross-reference R2 causes the selected icon I2 to be displayed for the display time Fzyx.

The fourth word of the sequence S is of the first type and defines a display time different from the previous one and equal to Fz′y′x′.

The fifth and sixth words of the sequence S are of the second type and define respective cross-references R′1 and R3 to the first and third icons I1 and I3 defined after the sequence S. The cross-references R′1 and R3 respectively cause the selected icons I1 and I3 to be displayed for the display time Fz′y′x′.

Note that the second cross-reference R′1 to the first icon I1 can correspond to a skip that is identical to or different from the first cross-reference R1 to the first icon I1. In the example shown, the cross-references are all expressed by a skip counted from the word indicating the size T of the sequence. R1 and R′1 are therefore identical.

In a first embodiment of the invention, the sequence S is defined in a data medium of the receiver terminal. The data structure is then constructed in the receiver terminal by collecting the icons contained in the message, for example in a buffer memory of the receiver terminal.

In this first case, the message in which the icons are defined can be an EMS (Enhanced Messaging Service) message.

In a second embodiment of the invention, the data structure is constructed in the message containing the icons transmitted between the sender terminal and the receiver terminal.

In this second case, the message transmitted between the sender terminal and the receiver terminal can be an SMS (Short Message Service) message.

When the data structure has been constructed, the sequence S is executed in the receiver terminal so that the display time of a selected icon is imposed by the last word of the first type that precedes the word of the second type referring to the selected icons.

The advantages of the invention include the fact that it enables the same icon to be used several times in an animation, although it is defined only once in the message, thanks to the cross-references defined in the sequence S.

The icon animation management method according to the invention can in particular manage animation of icons in a message taking the form of a file that can be downloaded into a receiver terminal.

The method according to the invention manages animation of a varying number of icons defined in a message, which number can be less than or greater than that of the FIG. 2 example, for example equal to 4, as in an EMS (Enhanced Messaging Service) message.

1. A method of managing animation of icons defined in a message transmitted over a telecommunication network between a sender terminal and a receiver terminal, wherein:
a data structure is constructed in which the icons are associated with a sequence of words for managing animation of said icons, including a first type of word defining an icon display time and a second type of word defining a cross-reference to a selected icon defined in the data structure, and
the sequence is executed so that the display time of a selected icon is imposed by the last word of the first type that precedes the word of the second type cross-referencing the selected icon.

2. A method according to claim 1, wherein the sequence is defined in a data medium of the receiver terminal and the data structure is constructed in the receiver terminal.

3. A method according to claim 2, wherein the message in which the icons are defined is an EMS message.

4. A method according to claim 1, wherein the data structure is constructed in the message transmitted between the sender terminal and the receiver terminal.

5. A method according to claim 4, wherein the message transmitted between the sender terminal and the receiver terminal is an SMS message.

6. A method according to claim 1, wherein the icons to be animated are defined one after the other in the data structure.

7. A method according to claim 1, wherein the icon defined first in the data structure is directly preceded by the animation management sequence.

8. A method according to claim 1, wherein, in the data structure, the animation management sequence is directly preceded by a word defining the size of the sequence.

9. A method according to claim 1, wherein the first word of the animation management sequence is of the first type.

10. A method according to claim 1, wherein the words and the icons are defined by bytes and the words of the second type define a byte skip.

11. A method according to claim 1, wherein the words of the first type defining an icon display time are coded by a series of bits including a first part defining a predetermined code identifying the type of word and a second part defining an icon display time parameter.

12. A method according to claim 1, wherein the words of the first and second types are numbers expressed in hexadecimal notation.

13. A method according to claim 12, wherein the words of the first and second types are coded on 16 bits.

14. A method according to claim 11, wherein the words of the first and second types are coded on 16 bits, and wherein, in words of the first type, the predetermined code identifying the type of word is coded by the first four bits and the icon display time parameter is coded by the last twelve bits.

15. A method according to claim 1, wherein the telecommunication network is a wireless network, in particular a GSM network.

16. A mobile terminal including means for implementing the method according to claim 1.

17. A data structure for managing animation of icons defined in a message transmitted over a telecommunication network between a sender terminal and a receiver terminal, the data structure including data defining the icons and a sequence of words for managing animation of the icons including a first type of word defining an icon display time and a second type of word defining a cross-reference to a selected icon defined in the data structure, the display time of a selected icon being imposed by the last word of the first type that precedes the word of the second type cross-referencing the selected icon.

18. A data structure according to claim 17, wherein the icons to be animated are defined one after the other in the data structure.

19. A data structure according to claim 18, wherein the icon defined first in the data structure is directly preceded by the animation management sequence.

20. A data structure according to claim 17, including a word defining the size of the animation management sequence and directly preceding the sequence.

21. A data structure according to claim 17, wherein the first word of the animation management sequence is of the first type.

22. A data structure according to claim 17, wherein the words and the icons are defined by bytes and the words of the second type define a byte skip.

23. A data structure according to claim 17, wherein the words of the first type defining an icon display time are coded by a series of bits including a first part defining a predetermined code identifying the type of word and a second part defining an icon display time parameter.

24. A data structure according to claim 17, wherein the words of the first and second types are numbers expressed in hexadecimal notation.

25. A data structure according to claim 24, wherein the words of the first and second types are coded on 16 bits.

26. A data structure according to claim 23, wherein the words of the first and second types are coded on 16 bits, and wherein, in words of the first type, the predetermined code identifying the type of word is defined by the first four bits and the icon display time parameter is defined by the last twelve bits.
